(19) United States
(12) Patent Application Publication
(10) Pub. No.: US 2024/0349023 A1
(43) Pub. Date: Oct. 17, 2024

(54) INFORMATION TRANSMISSION METHOD, FIRST ACCESS NETWORK DEVICE, SECOND ACCESS NETWORK DEVICE, AND TERMINAL

(71) Applicant: GUANGDONG OPPO MOBILE TELECOMMUNICATIONS CORP., LTD., Dongguan (CN)

(72) Inventor: Xinlei YU, Dongguan (CN)

(21) Appl. No.: 18/752,140

(22) Filed: Jun. 24, 2024

Related U.S. Application Data
(63) Continuation of application No. PCT/CN2021/141234, filed on Dec. 24, 2021.

(51) Int. Cl. H04W 4/38; H04W 72/0446; H04W 72/0453

(52) U.S. Cl. CPC H04W 4/38; H04W 72/0446; H04W 72/0453

(57) ABSTRACT

This application relates to an information transmission method. The method includes: sending, by a first access network device, a sensing request message to a second access network device, where the sensing request message includes sensing signal configuration information, and the sensing signal configuration information is used by the second access network device to receive a sensing signal.

### CROSS-REFERENCE TO RELATED APPLICATIONS

This application is a continuation of International Application No. PCT/CN2021/141234, filed on Dec. 24, 2021, the disclosure of which is hereby incorporated by reference in its entirety.

### TECHNICAL FIELD

This application relates to the communications field, and more specifically, to an information transmission method, a first access network device, a second access network device, a terminal, a chip, a computer-readable storage medium, a computer program product, a computer program, and a communications system.

### BACKGROUND

A current cellular network, including a fifth-generation (5G) network, is mainly used for communication. However, a wireless electromagnetic wave signal used in the cellular network not only can be used for wireless data transmission and communication, but also has an environment sensing capability, such as motion or gesture recognition, speed measurement, and imaging. Therefore, a future cellular network may be considered not only for communication and data transmission, but also for acquisition of sensing information.

In actual application, an application may send a sensing request to a core network in a cellular network, and a network element in the core network triggers an access network device or a terminal to execute a sensing-related operation, and configures information related to a sensing signal. However, this will result in large signaling overheads and a long delay.

### SUMMARY

In view of this, embodiments of this application provide an information transmission method, a first access network device, a second access network device, a terminal, a chip, a computer-readable storage medium, a computer program product, a computer program, and a communications system, which may be used to transmit sensing signal configuration information.

An embodiment of this application provides an information transmission method, including:
sending, by a first access network device, a sensing request message to a second access network device;
where the sensing request message includes sensing signal configuration information, and the sensing signal configuration information is used by the second access network device to receive a sensing signal.

An embodiment of this application provides an information transmission method, including:
receiving, by a second access network device, a sensing request message from a first access network device, where the sensing request message includes sensing signal configuration information; and
receiving, by the second access network device, a sensing signal based on the sensing signal configuration information.

An embodiment of this application further provides an information transmission method, including:
receiving, by a terminal, sensing signal configuration information from a first access network device; and
sending, by the terminal, a sensing signal based on the sensing signal configuration information.

An embodiment of this application further provides a first access network device, including:
a first communications module, configured to send a sensing request message to a second access network device;
where the sensing request message includes sensing signal configuration information, and the sensing signal configuration information is used by the second access network device to receive a sensing signal.

An embodiment of this application further provides a second access network device, including:
a third communications module, configured to receive a sensing request message from a first access network device, and receive a sensing signal based on sensing signal configuration information included in the sensing request message.

An embodiment of this application further provides a terminal, including:
a fourth communications module, configured to receive sensing signal configuration information from a first access network device, and send a sensing signal based on the sensing signal configuration information.

An embodiment of this application further provides a first access network device, including a processor and a memory, where the memory is configured to store a computer program, and the processor is configured to invoke and run the computer program stored in the memory to execute the information transmission method provided in any embodiment of this application.

An embodiment of this application further provides a chip, including a processor, configured to invoke a computer program from a memory and run the computer program, to cause a device on which the chip is installed to execute the information transmission method provided in any embodiment of this application.

An embodiment of this application further provides a computer-readable storage medium, configured to store a computer program, where the computer program causes a computer to execute the information transmission method provided in any embodiment of this application.

An embodiment of this application further provides a computer program product, including computer program instructions, where the computer program instructions cause a computer to execute the information transmission method provided in any embodiment of this application.

An embodiment of this application further provides a computer program, where the computer program causes a computer to execute the information transmission method provided in any embodiment of this application.

An embodiment of this application further provides a communications system, including a first access network device and a second access network device that are configured to execute the information transmission method provided in any embodiment of this application.

According to a method in embodiments of this application, configuration of a sensing signal may be directly coordinated between a first access network device and a second access network device, and auxiliary information configured for the sensing signal does not need to be reported to a core network element, thereby reducing signaling overheads and reducing a delay.

### BRIEF DESCRIPTION OF DRAWINGS

FIG. 1 is a schematic diagram of an architecture of a communications system according to an embodiment of this application.

FIG. 2 is a schematic diagram of an architecture of a 5G network system according to an embodiment of this application.

FIG. 3 is s flowchart of a UE-level sensing operation according to an embodiment of this application.

FIG. 4 is a flowchart of an area-level sensing operation according to an embodiment of this application.

FIG. 5 is a schematic flowchart of an information transmission method according to an embodiment of this application.

FIG. 6 is a schematic flowchart of an information transmission method according to another embodiment of this application.

FIG. 7 is a schematic flowchart of an information transmission method according to still another embodiment of this application.

FIG. 8 is a schematic flowchart of an application example 1 according to an embodiment of this application.

FIG. 9 is a schematic flowchart of an application example 2 according to an embodiment of this application.

FIG. 10 is a schematic structural block diagram of a first access network device according to an embodiment of this application.

FIG. 11 is a schematic structural block diagram of a first access network device according to another embodiment of this application.

FIG. 12 is a schematic structural block diagram of a second access network device according to an embodiment of this application.

FIG. 13 is a schematic structural block diagram of a second access network device according to another embodiment of this application.

FIG. 14 is a schematic structural block diagram of a terminal according to an embodiment of this application.

FIG. 15 is a schematic structural block diagram of a terminal according to another embodiment of this application.

FIG. 16 is a schematic block diagram of a communications device according to an embodiment of this application.

FIG. 17 is a schematic block diagram of a chip according to an embodiment of this application.

FIG. 18 is a schematic block diagram of a communications system according to an embodiment of this application.

FIG. 19 is a schematic block diagram of a communications system according to an embodiment of this application.

### DESCRIPTION OF EMBODIMENTS

The following describes the technical solutions in embodiments of this application in combination with the accompanying drawings in embodiments of this application.

The technical solutions in embodiments of this application may be applied to various communications systems, for example, a global system of mobile communication (GSM), a code division multiple access (CDMA) system, a wideband code division multiple access (WCDMA) system, general packet radio service (GPRS), a long-term evolution (LTE) system, an advanced long-term evolution (LTE-A) system, a new radio (NR) system, an evolved system of an NR system, an LTE-based access to unlicensed spectrum (LTE-U) system, an NR-based access to unlicensed spectrum (NR-U) system, a non-terrestrial networks (NTN) system, a universal mobile telecommunication system (UMTS), a wireless local area network (WLAN), a wireless fidelity (WiFi), a fifth-generation (5G) system, or another communications system.

Generally, a quantity of connections supported by a conventional communications system is limited and is also easy to implement. However, with development of communication technologies, a mobile communications system not only supports conventional communication, but also supports, for example, device-to-device (D2D) communication, machine to machine (M2M) communication, machine type communication (MTC), vehicle to vehicle (V2V) communication, or vehicle to everything (V2X) communication. Embodiments of this application may also be applied to these communications systems.

Optionally, a communications system in embodiments of this application may be applied to a carrier aggregation (CA) scenario, a dual connectivity (DC) scenario, or a standalone (SA) networking scenario.

Embodiments of this application are described with reference to an access network device and a terminal device. The terminal device may also be referred to as a user equipment (UE), an access terminal, a user unit, a user station, a mobile station, a mobile console, a remote station, a remote terminal, a mobile device, a user terminal, a terminal, a wireless communications device, a user agent, a user apparatus, or the like.

The terminal device may be a station (ST) in a WLAN, may be a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, an in-vehicle device, a wearable device, a terminal device in a next-generation communications system such as an NR network, a terminal device in a future evolved public land mobile network (PLMN), or the like.

In embodiments of this application, the terminal device may be deployed on land, including being indoors or outdoors, handheld, wearable, or in-vehicle. The terminal device may also be deployed on water (for example, on a ship), or may be deployed in the air (for example, on an airplane, an air balloon, or a satellite).

In embodiments of this application, the terminal device may be a mobile phone, a pad, a computer with a wireless transceiver function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, or the like.

By way of example rather than limitation, in embodiments of this application, the terminal device may alternatively be a wearable device. The wearable device may also be referred to as an intelligent wearable device, and is a general term for wearable devices such as glasses, gloves, watches, clothes, and shoes that are intelligently designed and developed based on daily wearing by using a wearable technology. The wearable device is a portable device that can be directly worn or integrated into clothes or accessories of a user. In addition to being a hardware device, the wearable device can also realize various functions through software support, data interaction, and cloud interaction. In a broad sense, wearable smart devices may include a full-featured and large-sized device that can provide full or partial functions without relying on a smart phone, for example, a smart watch or smart glasses, and devices that focus on only a specific type of application function and need to cooperate with another device such as a smart phone for use, for example, various smart bracelets and smart jewelries for physical sign monitoring.

In embodiments of this application, the access network device may be a device configured to communicate with a mobile device. The access network device may be an access point (AP) in a WLAN, may be a base transceiver station (BTS) in GSM or CDMA, may be a NodeB (NB) in WCDMA, or may be an evolved NodeB (eNB or eNodeB) in LTE, or a relay station or an access point, or an in-vehicle device or a wearable device, or an access network device (gNB) in an NR network, or an access network device in a future evolved PLMN network, or the like.

By way of example rather than limitation, in embodiments of this application, the access network device may have a mobility feature. For example, the access network device may be a mobile device. Optionally, the access network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the access network device may alternatively be a base station disposed in a location such as land or water.

In embodiments of this application, the access network device may provide a service for a cell. The terminal device communicates with the access network device by using a transmission resource (for example, a frequency domain resource or a spectrum resource) used by the cell. The cell may be a cell corresponding to the access network device (for example, a base station). The cell may belong to a macro station or may be a base station corresponding to a small cell. The small cell herein may include a metro cell, a micro cell, a pico cell, a femto cell, or the like. These small cells have a characteristic of a small coverage range and low transmit power, and are applicable to providing a high-rate data transmission service.

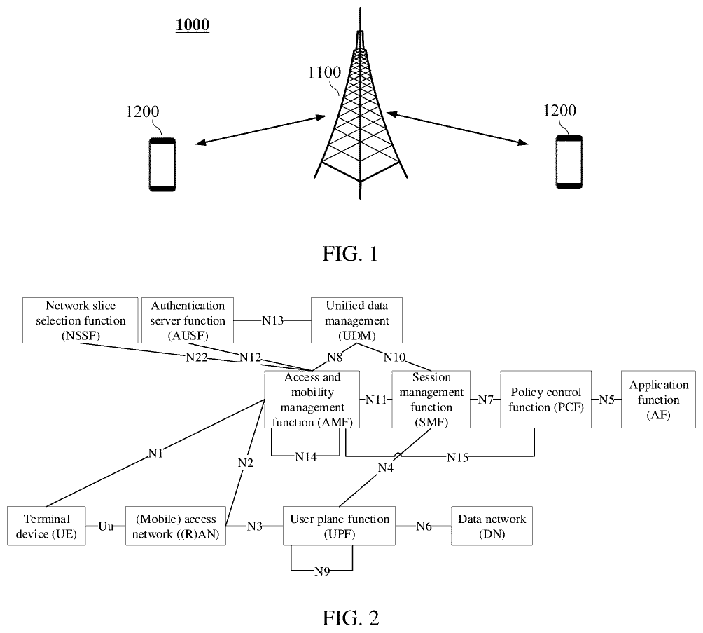

FIG. 1 schematically shows a wireless communications system 1000 that includes one access network device 1100 and two terminal devices 1200. Optionally, the wireless communications system 1000 may include a plurality of access network devices 1100, and a coverage range of each access network device 1100 may include another quantity of terminal devices.

Optionally, the wireless communications system further includes a core network configured to communicate with the access network device. For example, FIG. 2 is a schematic diagram of an architecture of a 5G network system. The 5G network includes a UE and an access network ((R)AN) device, and further includes a data network (DN), an application function (AF), and a plurality of core network elements. The plurality of core network elements include:
network slice selection function (NSSF);
authentication server function (AUSF);
unified data management (UDM);
access and mobility management function (AMF);
session management function (SMF);
policy control function (PCF); and
user plane function (UPF).

The UE performs an access stratum connection to an AN by using a Uu interface, and exchanges an access stratum message and wireless data transmission. The UE performs a non-access stratum (NAS) connection to the AMF by using an NI interface, and exchanges a NAS message. The AMF is a mobility management function in the core network, and the SMF is a session management function in the core network. In addition to performing mobility management on the UE, the AMF is also responsible for forwarding a message related to session management between the UE and the SMF. The PCF is a policy management function in the core network, and is responsible for formulating policies related to mobility management, session management, and charging of the UE. The UPF is a user plane function in the core network, and performs data transmission with an external data network by using an N6 interface and performs data transmission with the AN by using an N3 interface.

It should be understood that a device having a communication function in a network or a system in embodiments of this application may be referred to as a communications device. The communications system shown in FIG. 1 is used as an example. The communications device may include an access network device and a terminal device that have a communication function. The access network device and the terminal device may be specific devices in embodiments of this application.

Optionally, another network entity such as a mobility management entity (MME) or an access and mobility management function (AMF), is not limited in embodiments of this application.

It should be understood that the terms “system” and “network” may often be used interchangeably in this specification. In this specification, the term “and/or” is merely an association relationship that describes associated objects, and represents that there may be three relationships. For is described, A and/or B may represent three cases: only A exists, both A and B exist, and only B exists. In this specification, the character “/” herein generally indicates “or” relationship between the associated objects.

It should be understood that, the “indication” mentioned in embodiments of this application may be a direct indication or an indirect indication, or indicate an association. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association between A and B.

In the descriptions of embodiments of this application, the term “corresponding” may mean that there is a direct or indirect correspondence between two elements, or that there is an association between two elements, or that there is a relationship of “indicating” and “being indicated”, “configuring” and “being configured”, or the like.

To facilitate understanding of the technical solutions in embodiments of this application, the following describes related technologies in embodiments of this application. The following related technologies may be randomly combined with the technical solutions in embodiments of this application as optional solutions, which are all within the protection scope of embodiments of this application.

A current cellular network, including a 5G network, is used for communication only. However, a wireless electromagnetic wave signal used in the cellular network not only can be used for wireless data transmission and communication, but also has an environment sensing capability, such as motion or gesture recognition and respiration monitoring of a user, measurement of a moving speed of a terminal, environment imaging, and weather monitoring. Therefore, a future cellular network may be considered not only for communication and data transmission, but also for acquisition of sensing information.

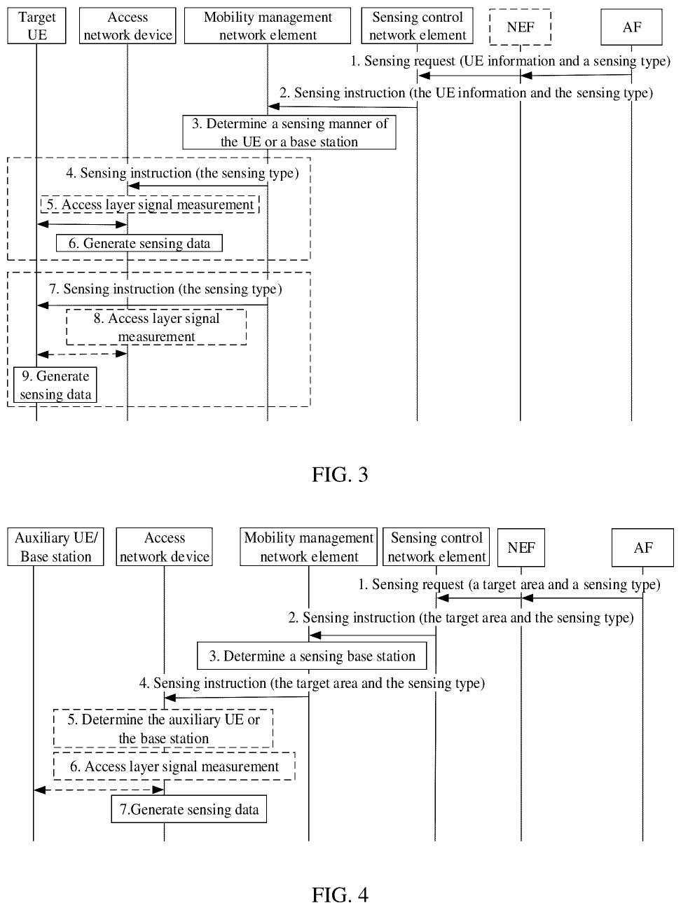

It may be considered that a sensing capability is supported in a B5G (Beyond 5th Generation, beyond 5G) network, and a sensing function is supported in the network by adding a sensing control network element (Sensing Function) and corresponding procedures. FIG. 3 is a possible flowchart of controlling an access network device or a UE to perform a UE-level sensing operation. FIG. 4 is a possible flowchart of controlling an access network device or a UE to perform an area-level sensing operation.

As shown in FIG. 3 and FIG. 4, when an application sends a sensing request for a target UE or a target area to a core network of a 3GPP network, the core network selects a proper access network device and/or a proper auxiliary UE by using a sensing control network element or an AMF, triggers a capability of performing sensing-related wireless measurement, starts measurement of sensing information, and generates a sensing result.

Integration of two functions such as communication and sensing may be referred to as integrated communication and sensing. Main wireless sensing scenarios of integrated communication and sensing include the following:
(1) A link for base station monostatic sensing: A base station sends a sensing signal and receives an echo signal.
(2) A link for base station to base station bistatic sensing: A base station B receives a sensing signal sent by a base station A.
(3) An uplink for bistatic sensing: A base station receives a sensing signal sent by a terminal.
(4) A downlink for bistatic sensing: A terminal receives a sensing signal sent by a base station.
(5) A link for terminal monostatic sensing: A terminal sends a sensing signal and receives an echo signal.
(6) A link for terminal device to terminal device bistatic sensing: A terminal B receives a sensing signal sent by a terminal A.

In an initial stage of integrated communication and sensing of B5G, an existing reference signal, such as a sounding reference signal (SRS), a demodulation reference signal (DMRS), a channel state information measurement reference signal (CSI-RS), a phase-tracking reference signal (PTRS), or a positioning reference signal (PRS), is considered to be used as much as possible, so as to perform sensing behavior without introducing excessive air interface enhancement.

In the foregoing related technology, for sensing of the target UE or the target area, the sensing control network element (SF) or the AMF of the core network is responsible for selecting the proper access network device (gNB) or the proper auxiliary UE, performing a sensing-related operation, and configuring a time-frequency position of a sensing reference signal.

Because the SF or the AMF does not master information about an air interface resource, when configuring the time-frequency position of the sensing signal, the access network device or the UE needs to report auxiliary information related to the time-frequency position of the sensing signal to the AMF or the SF. This increases signaling overheads and a delay.

The solutions provided in embodiments of this application are mainly used to resolve at least one of the foregoing problems.

To understand features and technical content of embodiments of the present application in more detail, the following describes implementation of embodiments of the present application in detail with reference to the accompanying drawings. The accompanying drawings are merely used for description, and are not intended to limit embodiments of the present application.

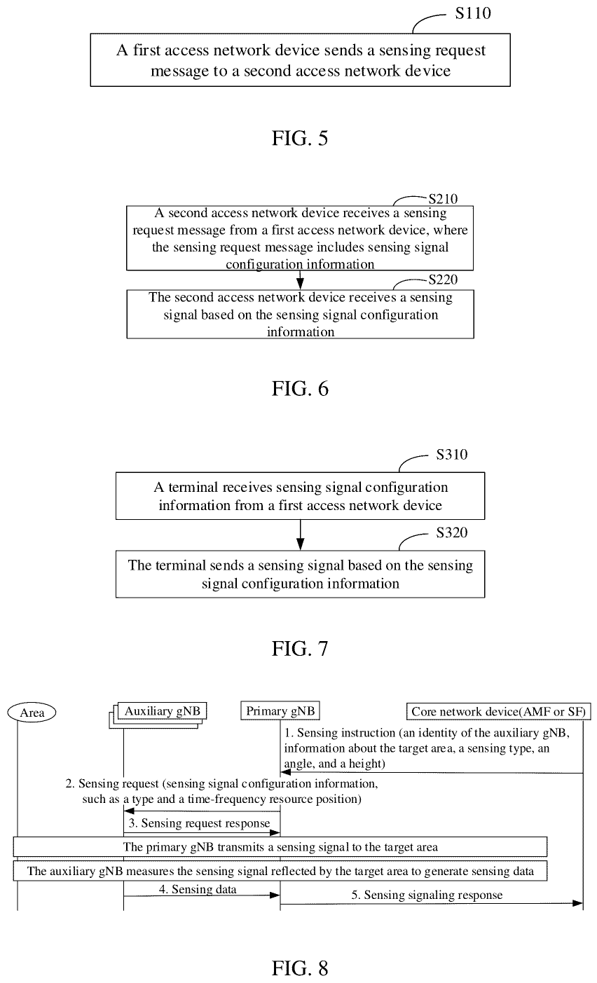

FIG. 5 is a schematic flowchart of a signal transmission method according to an embodiment of this application. The method includes at least a part of the following content.
S110. A first access network device sends a sensing request message to a second access network device.
The sensing request message includes sensing signal configuration information, and the sensing signal configuration information is used by the second access network device to receive a sensing signal.

Optionally, the sensing request message may be used to request or instruct the second access network device to assist in completing a sensing process. Specifically, the sensing request message may be used to request or instruct the second access network device to receive the sensing signal, so as to obtain sensing data based on the sensing signal.

Correspondingly to the foregoing method, an embodiment of this application further provides an information transmission method. As shown in FIG. 6, the method includes the following steps:
S210. A second access network device receives a sensing request message from a first access network device, where the sensing request message includes sensing signal configuration information.
S220. The second access network device receives a sensing signal based on the sensing signal configuration information.

According to the method in this embodiment of this application, configuration of a sensing signal may be directly coordinated between a first access network device and a second access network device, that is, the first access network device determines sensing signal configuration information, and sends the sensing signal configuration information to the second access network device that is configured to assist in sensing. Therefore, a core network element does not need to configure a sensing signal and send sensing signal configuration information to the second access network device. As a result, auxiliary information configured for the sensing signal does not need to be reported to the core network element, so that a technical effect of reducing signaling overheads and a delay can be achieved.

Optionally, in this embodiment of this application, the sensing signal may include a reference signal used for sensing, and may be referred to as a sensing reference signal. For example, the sensing signal may include at least one of an SRS, a DMRS, a PTRS, and a PRS.

Optionally, the sensing signal configuration information includes at least one of the following information:
a type of a sensing signal;
a time domain resource position of a sensing signal;
a frequency domain resource position of a sensing signal;
a start time of a sensing signal; and
an end time of a sensing signal.

For example, the sensing signal configuration information includes a frequency domain resource position of a sensing signal, and the second access network device may receive the sensing signal at the frequency domain resource position. For another example, the sensing signal configuration information includes a start time and an end time of a sensing signal, and the second access network device may receive the sensing signal between the start time and the end time. By exchanging the sensing signal configuration information, the second access network device can accurately receive the sensing signal.

Optionally, before the second access network device receives the sensing signal based on the sensing signal configuration information, the foregoing information transmission method further includes:
sending, by the second access network device, a sensing request response message to the first access network device.

For example, the sensing request response message is used to indicate that the sensing signal may be sent.

For different application scenarios, a sensing signal may be sent by different transmitting ends. For example, in a link for bistatic sensing between base stations for an area, the first access network device may send a sensing signal to a target area, so that the second access network device can receive the sensing signal reflected by the target area. For another example, in an uplink for bistatic sensing for a UE, a target terminal may send a sensing signal, so that the second access network device receives the sensing signal from the target terminal.

For example, the sensing request response message is used to instruct the first access network device to send a sensing signal to a target area. Correspondingly, the foregoing information transmission method further includes: in a case in which the first access network device receives the sensing request response message from the second access network device, sending, by the first access network device, the sensing signal to the target area.

The target area may be understood as a to-be-sensed area. By sending the sensing signal to the target area, the second access network device may receive the sensing signal transmitted by the target area, so as to obtain corresponding sensing data. For example, the sensing data is obtained by measuring the sensing signal.

For example, the sensing request response message is used to instruct the first access network device to send activation information to a terminal, and the activation information is used to instruct the terminal to activate the sensing signal configuration information, and to send the sensing signal based on the sensing signal configuration information. The terminal may include a to-be-sensed terminal, that is, a target terminal.

Optionally, the sensing signal configuration information on the terminal may be pre-configured by the first access network device. That is, the foregoing information transmission method may further include: sending, by the first access network device, the sensing signal configuration information to the terminal, where the sensing signal configuration information is further used by the terminal to send the sensing signal.

Correspondingly, an embodiment of this application further provides an information transmission method. Optionally, the method may be applied to the foregoing terminal, that is, applied to the sensed target terminal. As shown in FIG. 7, the method includes the following steps:
S310. A terminal receives sensing signal configuration information from a first access network device.
S320. The terminal sends a sensing signal based on the sensing signal configuration information.

Optionally, the foregoing sensing signal configuration information may be carried by radio resource control (RRC) dedicated signaling.

Because the first access network device sends the sensing signal configuration information to the terminal, a core network element does not need to configure a sensing signal and send sensing signal configuration information to the terminal. In addition, auxiliary information configured for the sensing signal does not need to be reported to the core network element, thereby achieving a technical effect of reducing signaling overheads and a delay.

Optionally, the foregoing information transmission method further includes: in a case in which the first access network device receives a sensing request response message from a second access network device, sending, by the first access network device, activation information to the terminal, where the activation information is used to instruct the terminal to activate the sensing signal configuration information, and to send the sensing signal based on the sensing signal configuration information.

Correspondingly, in the foregoing step S320, that the terminal sends a sensing signal based on the sensing signal configuration information may include:
in a case in which the terminal receives the activation information from the first access network device, activating, by the terminal, the sensing signal configuration information, and sending the sensing signal based on the sensing signal configuration information.

Optionally, for the second access network device, the foregoing information transmission method may further include:
obtaining, by the second access network device, sensing data based on the sensing signal, and sending the sensing data to the first access network device.

For example, the second access network device may receive a sensing signal reflected by a sensed target area, and obtain sensing data for the target area based on the sensing signal. Alternatively, the second access network device may receive a sensing signal sent by a sensed target terminal, to obtain sensing data for the target terminal. Optionally, the second access network device may obtain sensing data of a target terminal or a target area by measuring a sensing signal.

Correspondingly, for the first access network device, the foregoing information transmission method may further include:
receiving, by the first access network device, sensing data from the second access network device, and sending the sensing data to a core network device.

That is, the first access network device may collect sensing data, and report the sensing data to the core network device, so that the core network device feeds back sensing information to an application function that initiates a sensing request.

In actual application, there may be one or more second access network devices. That is, the first access network device may send the sensing signal configuration information to the one or more second access network devices, so that the plurality of second access network devices assist in completing a sensing procedure, thereby improving sensing accuracy.

Optionally, the sensing procedure may be initiated upon a request of the application function, and the application function sends the sensing request to the core network device, where a target area or a target terminal may be sensed. The core network device sends a sensing instruction to the first access network device, so as to trigger the first access network device to determine the sensing signal configuration information and to execute the sensing procedure. The sensing instruction may indicate information related to the target area or the target terminal, and may further indicate other sensing-related information, such as a sensing type and an identity of the second access network device that may be configured to assist in sensing.

To better understand the features of this embodiment of this application, the following provides two specific application examples with reference to a specific scenario.

### Application Example 1

In this application example, the first access network device is a primary base station (hereinafter referred to as a primary gNB) that completes a sensing procedure. The second access network device is an auxiliary base station (hereinafter referred to as an auxiliary gNB).

As shown in FIG. 8, in this application example, a specific implementation process is as follows:

Step 1: The primary gNB related to a target area receives a sensing instruction of a core network device (an AMF and/or an SF), where the sensing instruction may include a sensing type, such as bistatic sensing between base stations (gNB-gNBs) or gNB monostatic sensing. Optionally, the sensing instruction may also include information about the target area, such as an angle or a height.

If the sensing type is bistatic sensing between gNB-gNBs, the sensing instruction further includes an identity (or an identity list) of the auxiliary gNB.

Step 2: In a case in which the sensing type is bistatic sensing between gNB-gNBs, the primary gNB sends a sensing request message to the indicated auxiliary gNB through an Xn interface, where the sensing request message may carry sensing signal configuration information, such as a type of a sensing signal (a reference signal type), a time-frequency resource position, and a start time or an end time.

Step 3: After the primary gNB receives a sensing request response message of the auxiliary gNB, the primary gNB transmits a sensing signal to the target area, and the auxiliary gNB measures the sensing signal reflected by the target area to generate sensing data.

Step 4: The primary gNB receives sensing data of one or more auxiliary gNBs, and feeds back the sensing data to the core network device.

It can be learned that, that a sensing request message is sent between base stations through an Xn interface is introduced. For an inter-base station sensing scenario, sending and receiving of a sensing signal is directly coordinated between a primary base station and an auxiliary base station, so as to complete a sensing procedure. Auxiliary information configured for the sensing signal does not need to be reported to an SF or an AMF, thereby reducing signaling overheads and a delay.

### Application Example 2

In this application example, the first access network device is a sensed serving base station (hereinafter referred to as a serving gNB) of a target UE. The second access network device is an auxiliary gNB.

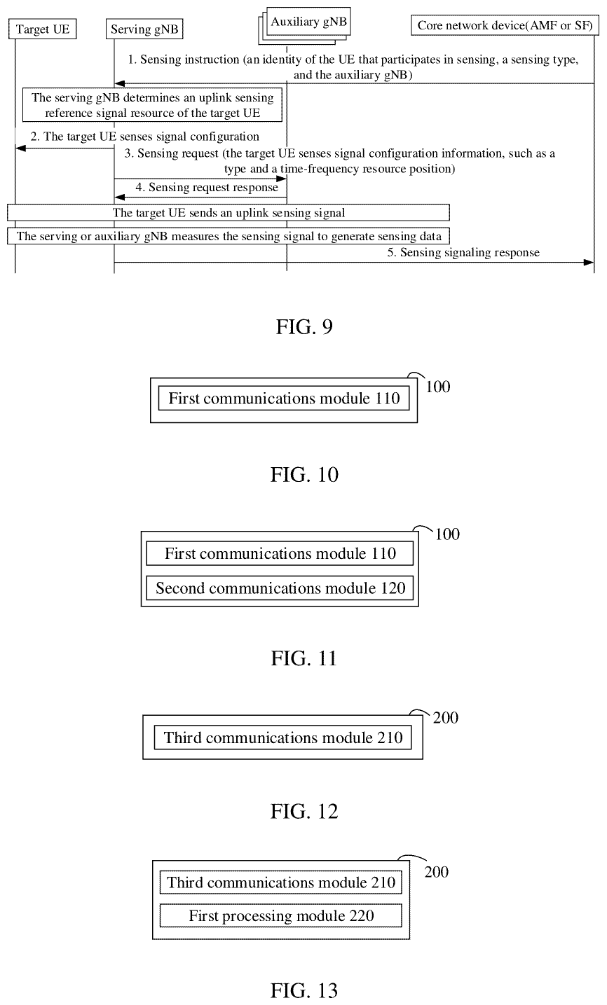

As shown in FIG. 9, in this application example, a specific implementation process is as follows:

Step 1: The serving gNB in which the target UE is located receives a sensing instruction of a core network device (an AMF and/or an SF), where a message of the sensing instruction may indicate a sensing type, for example, uplink bistatic sensing (UE-gNB uplink sensing).

If the sensing type is UE-gNB uplink bistatic sensing, the sensing instruction further includes an identity of the UE that participates in sensing and an identity of the auxiliary gNB.

Step 2: In a case in which the sensing type is UE-gNB uplink bistatic sensing, the serving gNB determines an uplink sensing reference signal resource of the target UE, and sends sensing signal configuration information to the target UE.

Optionally, the configuration information may be carried in RRC dedicated signaling.

Step 3: In a case in which the sensing type is UE-gNB uplink bistatic sensing, the serving gNB sends, based on the identity of the auxiliary gNB, a sensing request message to the indicated auxiliary gNB through an Xn interface. The sensing request message may carry sensing reference signal configuration information, such as a type of a sensing signal, a time-frequency resource position of a sensing signal, and a start time or an end time.

Step 4: After receiving a sensing request response message of the auxiliary gNB, the serving gNB instructs the target UE to activate the sensing signal configuration information and to send an uplink sensing signal. The auxiliary gNB measures the sensing signal to generate sensing data.

Step 5: The serving gNB receives sensing data of one or more auxiliary gNBs, and feeds back the sensing data to the core network device.

It can be learned that, that a sensing request message is sent between base stations through an Xn interface is introduced. For an uplink bistatic sensing scenario, sending and receiving of a sensing signal is directly coordinated between a serving base station and an auxiliary base station, so as to complete a sensing procedure. Auxiliary information configured for the sensing signal does not need to be reported to an SF or an AMF, thereby reducing signaling overheads and a delay.

The foregoing describes specific settings and implementations of embodiments of this application from different perspectives by using a plurality of embodiments. By using at least one of the foregoing embodiments, configuration of a sensing signal may be directly coordinated between a first access network device and a second access network device, and auxiliary information configured for the sensing signal does not need to be reported to a core network element, thereby reducing signaling overheads and a delay.

Corresponding to the processing method in at least one of the foregoing embodiments, an embodiment of this application further provides a first access network device 100. Referring to FIG. 10, the first access network device 100 includes:
a first communications module 110, configured to send a sensing request message to a second access network device;
where the sensing request message includes sensing signal configuration information, and the sensing signal configuration information is used by the second access network device to receive a sensing signal.

Optionally, the first communications module 110 is specifically configured to:
send, through an Xn interface, the sensing request message to the second access network device.

Optionally, the sensing signal configuration information includes at least one of the following information:
a type of a sensing signal;
a time domain resource position of a sensing signal;
a frequency domain resource position of a sensing signal;
a start time of a sensing signal; and
an end time of a sensing signal.

Optionally, the first communications module 110 is further configured to:
in a case in which a sensing request response message from the second access network device is received, send a sensing signal to a target area.

Optionally, the first communications module 110 is further configured to:
send the sensing signal configuration information to a terminal, where the sensing signal configuration information is further used by the terminal to send a sensing signal.

Optionally, the sensing signal configuration information is carried by radio resource control RRC dedicated signaling.

Optionally, the first communications module 110 is further configured to:
in a case in which the sensing request response message from the second access network device is received, send activation information to the terminal, where the activation information is used to instruct the terminal to activate the sensing signal configuration information, and to send the sensing signal based on the sensing signal configuration information.

Optionally, the sensing signal is used by the second access network device to obtain sensing data. As shown in FIG. 11, the first access network device 100 further includes:
a second communications module 120, configured to receive the sensing data from the second access network device, and send the sensing data to a core network device.

The first access network device 100 in this embodiment of this application can implement corresponding functions of the first access network device in the foregoing method embodiments. For procedures, functions, implementations, and beneficial effects corresponding to modules (submodules, units, or components) in the first access network device 100, refer to corresponding descriptions in the foregoing method embodiments. Details are not described herein again. It should be noted that functions described by modules (submodules, units, or components) in the first access network device 100 in this embodiment of this application may be implemented by different modules (submodules, units, or components), or may be implemented by a same module (submodule, unit, or component). For example, the first communications module and the second communications module may be different modules or may be a same module, and corresponding functions in this embodiment of this application can be implemented. In addition, the communications modules in this embodiment of this application may be implemented by using a transceiver of the device, and some or all of the remaining modules may be implemented by using a processor of the device.

FIG. 12 is a schematic block diagram of a second access network device 200 according to an embodiment of this application. The second access network device 200 may include:
a third communications module 210, configured to receive a sensing request message from a first access network device, and receive a sensing signal based on sensing signal configuration information included in the sensing request message.

Optionally, the third communications module is specifically configured to:
receive, through an Xn interface, the sensing request message from the first access network device.

Optionally, the sensing signal configuration information includes at least one of the following information:
a type of a sensing signal;
a time domain resource position of a sensing signal;
a frequency domain resource position of a sensing signal;
a start time of a sensing signal; and
an end time of a sensing signal.

Optionally, the third communications module 210 is further configured to:
before the sensing signal is received based on the sensing signal configuration information, send a sensing request response message to the first access network device.

Optionally, the sensing request response message is used to instruct the first access network device to send a sensing signal to a target area.

Optionally, the sensing request response message is used to instruct the first access network device to send activation information to a terminal, and the activation information is used to instruct the terminal to activate the sensing signal configuration information, and to send the sensing signal based on the sensing signal configuration information.

Optionally, as shown in FIG. 13, the second access network device 200 further includes a first processing module 220, configured to obtain sensing data based on the sensing signal.

The third communications module 210 is further configured to send the sensing data to the first access network device.

The second access network device 200 in this embodiment of this application can implement corresponding functions of the second access network device in the foregoing method embodiments. For procedures, functions, implementations, and beneficial effects corresponding to modules (submodules, units, or components) in the second access network device 200, refer to corresponding descriptions in the foregoing method embodiments. Details are not described herein again. It should be noted that functions described by modules (submodules, units, or components) in the second access network device 200 in this embodiment of this application may be implemented by different modules (submodules, units, or components), or may be implemented by a same module (submodule, unit, or component), which can implement corresponding functions in this embodiment of this application. In addition, the communications modules in this embodiment of this application may be implemented by using a transceiver of the device, and some or all of the remaining modules may be implemented by using a processor of the device.

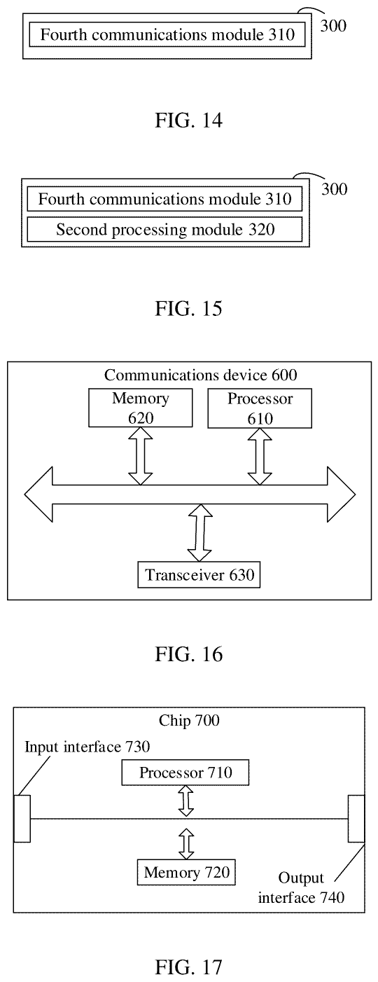

FIG. 14 is a schematic block diagram of a terminal 300 according to an embodiment of this application. The terminal 300 may include:
a fourth communications module 310, configured to receive sensing signal configuration information from a first access network device, and send a sensing signal based on the sensing signal configuration information.

Optionally, the sensing signal configuration information is carried by radio resource control RRC dedicated signaling.

Optionally, the sensing signal configuration information includes at least one of the following information:
a type of a sensing signal;
a time domain resource position of a sensing signal;
a frequency domain resource position of a sensing signal;
a start time of a sensing signal; and
an end time of a sensing signal.

Optionally, as shown in FIG. 15, the terminal 300 further includes a second processing module 320, configured to: in a case in which activation information from the first access network device is received, activate the sensing signal configuration information. The fourth communications module 310 is specifically configured to send the sensing signal based on the sensing signal configuration information after the sensing signal configuration information is activated.

The terminal 300 in this embodiment of this application can implement corresponding functions of the terminal in the foregoing method embodiments. For procedures, functions, implementations, and beneficial effects corresponding to modules (submodules, units, or components) in the terminal 300, refer to corresponding descriptions in the foregoing method embodiments. Details are not described herein again. It should be noted that functions described by modules (submodules, units, or components) in the terminal 300 in this embodiment of this application may be implemented by different modules (submodules, units, or components), or may be implemented by a same module (submodule, unit, or component), which can implement corresponding functions in this embodiment of this application. In addition, the communications modules in this embodiment of this application may be implemented by using a transceiver of the device, and some or all of the remaining modules may be implemented by using a processor of the device.

FIG. 16 is a schematic structural diagram of a communications device 600 according to an embodiment of this application. The communications device 600 includes a processor 610, and the processor 610 may invoke a computer program from a memory and run the computer program to implement a method in embodiments of this application.

Optionally, the communications device 600 may further include a memory 620. The processor 610 may invoke a computer program from the memory 620 and run the computer program to implement a method in embodiments of this application.

The memory 620 may be a separate component independent of the processor 610, or may be integrated into the processor 610.

Optionally, the communications device 600 may further include a transceiver 630. The processor 610 may control the transceiver 630 to communicate with another device, and specifically, may send information or data to the another device, or receive information or data sent by the another device.

The transceiver 630 may include a transmitter and a receiver. The transceiver 630 may further include an antenna, and a quantity of the antenna may be one or more.

Optionally, the communications device 600 may be a first access network device or a second access network device or a terminal in embodiments of this application, and the communications device 600 may implement corresponding procedures implemented by the first access network device or the second access network device in the methods according to embodiments of this application. For brevity, details are not described herein again.

FIG. 17 is a schematic structural diagram of a chip 700 according to an embodiment of this application. The chip 700 includes a processor 710, and the processor 710 may invoke a computer program from a memory and run the computer program to implement a method in embodiments of this application.

Optionally, the chip 700 may further include a memory 720. The processor 710 may invoke a computer program from the memory 720 and run the computer program to implement a method in embodiments of this application.

The memory 720 may be a separate component independent of the processor 710, or may be integrated into the processor 710.

Optionally, the chip 700 may further include an input interface 730. The processor 710 may control the input interface 730 to communicate with another device or chip, and specifically, may obtain information or data sent by the another device or chip.

Optionally, the chip 700 may further include an output interface 740. The processor 710 may control the output interface 740 to communicate with another device or chip, and specifically, may output information or data to the another device or chip.

Optionally, the chip may be applied to a first access network device or a second access network device or a terminal in embodiments of this application, and the chip may implement corresponding procedures implemented by the first access network device or the second access network device in the methods according to embodiments of this application. For brevity, details are not described herein again.

It should be understood that the chip mentioned in this embodiment of this application may also be referred to as a system-level chip, a system chip, a chip system, or a system-on-chip.

The processor mentioned above may be a general-purpose processor, a digital signal processor (DSP), a field programmable gate array (FPGA), an application-specific integrated circuit (ASIC) or another programmable logic device, a transistor logic device, a discrete hardware component, or the like. The general-purpose processor mentioned above may be a microprocessor, or may be any conventional processor.

The memory mentioned above may be a volatile memory or a non-volatile memory, or may include both a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM).

It should be understood that, by way of example but not limitative description, for example, the memory in this embodiment of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synch link DRAM, SLDRAM), a direct Rambus random access memory (Direct Rambus RAM, DR RAM), or the like. In other words, the memory in this embodiment of this application includes but is not limited to these memories and any memory of another proper type.

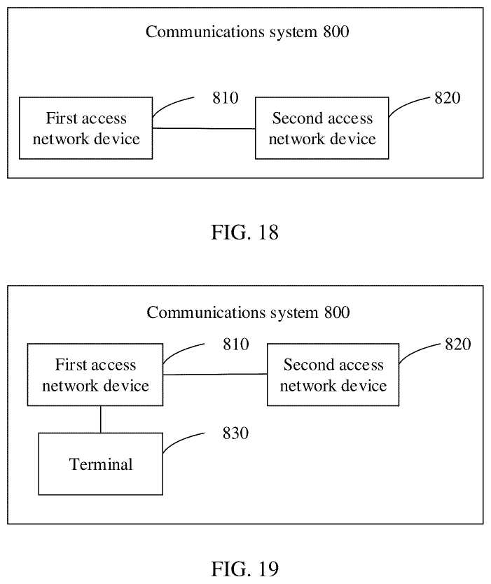

FIG. 18 is a schematic block diagram of a communications system 800 according to an embodiment of this application. The communications system 800 includes a first access network device 810 and a second access network device 820.

The first access network device 810 sends a sensing request message to the second access network device 820.

The sensing request message includes sensing signal configuration information, and the sensing signal configuration information is used by the second access network device 820 to receive a sensing signal.

The second access network device 820 receives the sensing request message from the first access network device 810, and receives a sensing signal based on sensing signal configuration information included in the sensing request message.

Optionally, as shown in FIG. 19, the communications system 800 may further include a terminal 830. The terminal 830 receives the sensing signal configuration information sent by the first access network device 810, and sends a sensing signal based on the sensing signal configuration information.

The terminal device 810 may be configured to implement corresponding functions implemented by a terminal device in the methods according to embodiments of this application, and the network device 820 may be configured to implement corresponding functions implemented by a network device in the methods according to embodiments of this application. For brevity, details are not described herein again.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any available medium accessible by a computer or a data storage device such as a server or a data center that integrates one or more available media. The available medium may be a magnetic medium (for example, a floppy disk, a hard disk, or a magnetic tape), an optical medium (for example, a DVD), a semiconductor medium (for example, a solid state disk (SSD)), or the like.

It should be understood that, in embodiments of this application, sequence numbers of the foregoing processes do not mean execution sequences. The execution sequences of the processes should be determined according to functions and internal logic of the processes, and should not be construed as any limitation on the implementation processes of embodiments of this application.

It may be clearly understood by a person skilled in the art that, for convenient and brief description, for a detailed working process of the foregoing system, apparatus, and unit, refer to corresponding processes in the foregoing method embodiments, and details are not described herein again.

In the descriptions of this specification, refer to the descriptions of the term “one embodiment”, “some embodiments”, “examples”, “specific examples”, or “some examples”, which mean that specific features, structures, materials, or features described in the embodiment or the example are included in at least one embodiment or example of the present application. Further, specific features, structures, materials, or features described may be incorporated in an appropriate manner in any one or more embodiments or examples. In addition, without being contradictory, a person skilled in the art may integrate and combine different embodiments or examples described in this specification and features of different embodiments or examples.

In addition, the terms “first” and “second” are used for purposes of description only and are not to be understood as indicating or implying relative importance or implying a quantity of indicated technical features. Therefore, a feature defined as “first” or “second” may explicitly or implicitly include at least one feature. In the descriptions of the present application, “a plurality of” means two or more, unless otherwise specifically limited.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An information transmission method, comprising:
sending, by a first access network device, a sensing request message to a second access network device;
wherein the sensing request message comprises sensing signal configuration information, and the sensing signal configuration information is used by the second access network device to receive a sensing signal.

2. The method according to claim 1, wherein the sensing signal configuration information comprises at least one of following information:
a type of a sensing signal;
a time domain resource position of a sensing signal;
a frequency domain resource position of a sensing signal;
a start time of a sensing signal; and
an end time of a sensing signal.

3. The method according to claim 1, wherein the method further comprises:
in a case in which the first access network device receives a sensing request response message from the second access network device, sending, by the first access network device, a sensing signal to a target area.

4. The method according to claim 1, wherein the method further comprises:
sending, by the first access network device, the sensing signal configuration information to a terminal, wherein the sensing signal configuration information is further used by the terminal to send a sensing signal.

5. The method according to claim 4, wherein the method further comprises:
in a case in which the first access network device receives a sensing request response message from the second access network device, sending, by the first access network device, activation information to the terminal, wherein the activation information is used to instruct the terminal to activate the sensing signal configuration information, and to send the sensing signal based on the sensing signal configuration information.

6. The method according to claim 1, wherein the sensing signal is used by the second access network device to obtain sensing data, and the method further comprises:
receiving, by the first access network device, the sensing data from the second access network device, and sending the sensing data to a core network device.

7. An information transmission method, comprising:
receiving, by a second access network device, a sensing request message from a first access network device, wherein the sensing request message comprises sensing signal configuration information; and
receiving, by the second access network device, a sensing signal based on the sensing signal configuration information.

8. The method according to claim 7, wherein the sensing signal configuration information comprises at least one of following information:
a type of a sensing signal;
a time domain resource position of a sensing signal;
a frequency domain resource position of a sensing signal;
a start time of a sensing signal; and
an end time of a sensing signal.

9. The method according to claim 7, wherein before the receiving, by the second access network device, a sensing signal based on the sensing signal configuration information, the method further comprises:
sending, by the second access network device, a sensing request response message to the first access network device.

10. The method according to claim 9, wherein the sensing request response message is used to instruct the first access network device to send a sensing signal to a target area.

11. The method according to claim 9, wherein the sensing request response message is used to instruct the first access network device to send activation information to a terminal, and the activation information is used to instruct the terminal to activate the sensing signal configuration information, and to send the sensing signal based on the sensing signal configuration information.

12. The method according to claim 7, wherein the method further comprises:
obtaining, by the second access network device, sensing data based on the sensing signal, and sending the sensing data to the first access network device.

13. A first access network device, comprising a processor and a memory, wherein the memory is configured to store a computer program, and the processor is configured to invoke and run the computer program stored in the memory to enable the first access network device to perform:
sending a sensing request message to a second access network device;
wherein the sensing request message comprises sensing signal configuration information, and the sensing signal configuration information is used by the second access network device to receive a sensing signal.

14. The first access network device according to claim 13, wherein the sensing signal configuration information comprises at least one of following information:
a type of a sensing signal;
a time domain resource position of a sensing signal;
a frequency domain resource position of a sensing signal;
a start time of a sensing signal; and
an end time of a sensing signal.

15. The first access network device according to claim 13, wherein the processor is configured to enable the first access network device to perform:
in a case in which the first access network device receives a sensing request response message from the second access network device, sending a sensing signal to a target area.

16. The first access network device according to claim 13, wherein the processor is configured to enable the first access network device to perform:
sending the sensing signal configuration information to a terminal, wherein the sensing signal configuration information is further used by the terminal to send a sensing signal.

17. The first access network device according to claim 16, wherein the processor is configured to enable the first access network device to perform:
in a case in which the first access network device receives a sensing request response message from the second access network device, sending activation information to the terminal, wherein the activation information is used to instruct the terminal to activate the sensing signal configuration information, and to send the sensing signal based on the sensing signal configuration information.

18. The first access network device according to claim 13, wherein the sensing signal is used by the second access network device to obtain sensing data, and the processor is configured to enable the first access network device to perform:
receiving the sensing data from the second access network device, and sending the sensing data to a core network device.

19. A second access network device, comprising a processor and a memory, wherein the memory is configured to store a computer program, and the processor is configured to invoke and run the computer program stored in the memory to enable the second access network device to perform the method according to claim 7.

20. The second access network device according to claim 19, wherein the sensing signal configuration information comprises at least one of following information:
a type of a sensing signal;
a time domain resource position of a sensing signal;
a frequency domain resource position of a sensing signal;
a start time of a sensing signal; and
an end time of a sensing signal.
